(19) United States
(12) Patent Application Publication
(10) Pub. No.: US 2002/0091542 A1
(43) Pub. Date: Jul. 11, 2002

(54) Computer implemented method of paying intellectual property annuity and maintenance fees

(75) Inventor: Jeffry J. Grainger, Portola Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: FIRST TO FILE, INC, Menlo Park, CA (US)

(21) Appl. No.: 09/997,203

(22) Filed: Nov. 27, 2001

Related U.S. Application Data
(60) Provisional application No. 60/309,237, filed on Jul. 31, 2001.
(60) Provisional application No. 60/253,360, filed on Nov. 27, 2000.

(51) Int. Cl. G06F 17/60

(52) U.S. Cl. 705/1

(57) ABSTRACT

A computer-implemented method of allowing payment of an annuity or maintenance fee associated with a patent document. In one embodiment the method includes (a) storing, on a computer readable medium accessible to a server system, patent information related to the patent document the patent information including one or more of a patent claim and a summary section; (b) generating, from the server system, a notice of a due date for the annuity or the maintenance fee; (c) communicating the notice to a first designated client system via a Web page, wherein the Web page allows said client system to system to view the information and indicate whether the annuity or the maintenance fee should be paid; (d) receiving a payment instruction from the client system regarding payment of the annuity or the maintenance fee; (e) storing the payment instruction in a database; and (e) communicating the payment instruction to a second designated client system. In another embodiment the second designated client system is an annuity/maintenance fee payment service that pays the fee pays and thereafter, communicates confirmation of the payment to the server system.

### CROSS-REFERENCES TO RELATED APPLICATIONS

This application claims priority to U.S. Provisional Application No. 60/309,237, filed Jul. 31, 2001, which is incorporated herein by reference. This application also claims priority to U.S. Provisional Application No. 60/253,360, entitled DATA PROCESSING SYSTEM FOR MANAGING INTELLECTUAL PROPERTY, filed on Nov. 27, 2000 and listing Jeffry J. Grainger as inventor. The disclosures of 60/309,237 and 60/253,360 are hereby incorporated herein by reference in their entirety.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to managing intellectual property. More particularly, embodiments of the invention relate to a computer-implemented method of requesting and receiving instructions for the payment of annuity and maintenance fees associated with patent applications and other intellectual property documents.

As the world economy has become more information and technology oriented, patents and other intellectual property are of growing importance. In order to secure such intellectual property rights appropriate paperwork needs to be completed and filed in an intellectual property office. For example, in order to secure patent protection within the United States, a patent application describing and claiming an invention needs to be filed in the United States Patent and Trademark Office (hereinafter “USPTO”). Once filed, previously established rules and guidelines are followed by a Patent Examiner to determine whether or not patent rights to the invention should be granted. Typically, the applicant for obtaining these rights includes filing multiple communications between the patentee and the patent office with many of such communications requiring a response within a given time period.

Additionally, depending on the country in which protection is sought, a patent applicant will be required to pay one or more annuity fees during the life of the patent or patent application or one or more maintenance fees after a patent is granted. Most countries require the payment of yearly annuity fees. The United States does not require payment of annuity fees, but instead requires maintenance fee payments at intervals of 3½, 7½ and 11½ years after issuance of the patent in order to maintain an issued patent in force.

The payment of such annuity fees and maintenance fees is an administrative task that can become quite burdensome. Typically, companies and law firms contract with various service providers such as Computer Packages, Inc. (CPI) or others. While contracting the payment of these fees to a third party relieves the law firm or company from many of the administrative burdens associated with the fees, a problem still exists in the decision making process. Namely, annuity and maintenance fee payment decisions are frequently made with incomplete information because obtaining the necessary or desired information is often quite burdensome. For example, it may be desirable when deciding to pay an annuity or maintenance fee on a particular file to review the allowed or pending claims, review the abstract, summary of the invention or detailed description, to review previous payment decisions, to review comments related to the importance of the patent application and/or to review decisions made for payment of annuity or maintenance fees for related applications, such as foreign counterpart applications. Typically, however, detailed information such as this is not easily and readily available to the decision maker, and even if available, it is not linked or associated in any way with the annuity or maintenance fee instruction request.

Accordingly, as can be appreciated from the above, improved methods of allowing payment decisions for annuity and maintenance fee payments to be made are desirable.

### BRIEF SUMMARY OF THE INVENTION

Embodiments of the present invention pertain to a system and method for allowing payment decisions for annuity and maintenance fee payments associated with an intellectual property document such as a patent document (e.g., a granted patent or pending patent application) to be made.

According to one embodiment, a computer-implemented method of allowing payment of an annuity or maintenance fee associated with a patent document is disclosed. In this embodiment the method includes (a) storing, on a computer readable medium accessible to a server system, patent information related to the patent application, the patent information including one or more of a patent claim and a summary section; (b) generating, from the server system, a notice of a due date for the annuity or the maintenance fee; (c) communicating the notice to a first designated client system via a Web page, wherein the Web page allows said client system to view the patent information and indicate whether the annuity or the maintenance fee should be paid; (d) receiving a payment instruction from the client system regarding payment of the annuity or the maintenance fee; (e) storing the payment instruction in a database; and (e) communicating the payment instruction to a second designated client system. In another embodiment the second designated client system is an annuity/maintenance fee payment service that pays the fee pays and thereafter, communicates confirmation of the payment to the server system.

Other embodiments of the invention pertain to a method of allowing payment of annuity fees associated with intellectual property documents other than patent documents, including trademark applications.

These and additional embodiments of the present invention, as well as its advantages and features, are described in more detail in conjunction with the text below and attached figures.

### BRIEF DESCRIPTION OF THE DRAWINGS

FIG. 1 is a simplified block diagram showing the relationship between an intellectual property (IP) data processing system 100 according to one embodiment of the present invention and participants in the patent process;

FIGS. 2A-2C are exemplary Web pages that can be used to define routing rules for requesting payment instructions for annuity and/or maintenance fee payments IP data processing system 100;

FIG. 3 is an example Web page that is used to request and receive annuity and maintenance fee payment instructions from a client system in one embodiment of the invention;

FIGS. 4, 5 and 6 are exemplary Web pages that can be generated by IP data processing system 100 to provide various features according to certain embodiments of the invention; and

FIG. 7 is a diagram showing communications between IP data processing system 100, a technology developer 110(i) and an annuity/maintenance fee payment service 130(i) according to one embodiment of the invention.

### DETAILED DESCRIPTION OF THE INVENTION

The present invention provides a novel and useful method and system for calculating patent term extensions for a granted patent application. The method can be embodied in, among other systems, a stand-alone computer system or a distributed computer network. For convenience, the description of one embodiment of the invention is set forth below with respect to an application service provider (ASP) model that communicates with client systems over the Internet. In this ASP model, an intellectual property data processing system 100 tracks all data necessary for calculating patent term adjustments, performs the term adjustment calculation and notifies an appropriate user of a calculated adjustment when appropriate. One of ordinary skill in the art would recognize other variations, modifications and alternatives to this embodiment. Accordingly, the ASP system described below is not intended to limit the scope of the invention in any way.

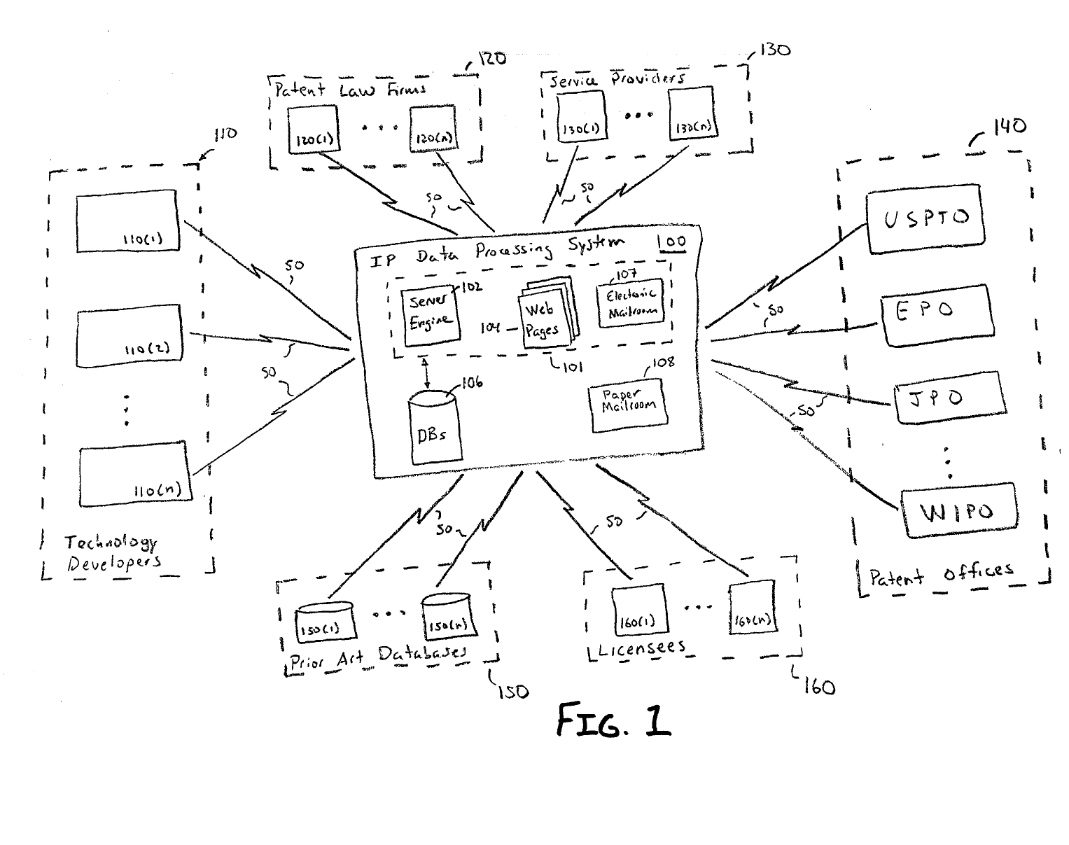

FIG. 1 is a simplified block diagram showing the relationship between an intellectual property (IP) data processing system 100 according to one embodiment of the present invention and participants in the patent process. IP data processing system 100 is a Web-enabled electronic platform that can be utilized by all participants in the patent process to convert the traditional paper-based patent prosecution system into an electronic workflow pipeline that allows every step in the process to be executed from a computer desktop.

The participants shown in FIG. 1 include technology developers 110, patent law firms 120, service providers 130, patent offices 140, prior art databases 150 and potential licensees 160. For convenience, each of these participants is referenced by a dotted line that encompasses individual entities of the participant type. For example, technology developers 110 are shown in FIG. 1 as including individual technology developers 110(1), 110(2) through 110(n). It is to be understood that, while shown in FIG. 1 as a group, these multiple technology developers are separate entities that likely have no relation to each other than their classification within this patent application as developers of technology. It is also to be understood that, while not shown, each individual participant system typically includes its own firewall system that implements access control functions to isolate the system from unwanted intrusions by others.

Each of the participants shown in FIG. 1 can communicate and exchange information through Internet 50. A person of ordinary skill in the art would recognize that in other embodiments the participants may communicate and exchange information using other communication network mediums including a local or wide area network (LAN or WAN), a wireless network, an intranet, a virtual private network and the like.

Technology developers 110 include corporations, universities and individual inventors seeking to file patent applications and receive issued patents. Patent law firms 120 include U.S. patent attorneys, patent agents and foreign patent attorneys and/or agents. Service providers 130 include patent draftsman, prior art search companies, translation companies and other entities that provide services useful to the patent process as well as financial institutions and other parties that have tangential roles in the process. Prior art databases 150 include public and licensed private databases, such as online patent databases (e.g., issued U.S. patents, published European and Japanese patents, etc.) and non-patent databases. Patent offices 140 include patent offices worldwide including the USPTO, the European Patent Office (EPO), the Japanese Patent Office (JPO), the Taiwanese Patent Office, etc.

Processing system 100 provides technology developers 110 and their associated patent law firms 120 a highly secure, central data repository that can be shared between participants on an as-allowed basis. Information generated and used during the patent prosecution process can be shared between a technology developer 110 and appropriate patent law firm(s) 120 and service provider(s) 130 in order to create patent filings, prosecute such filings through issuance and then subsequently maintain patent rights after grant.

As shown in FIG. 1, IP data processing system 100 includes a Web server 101, a database 106 and paper mailroom 108. Web server 101 includes a server engine 102 that generates and sends graphical documents including Web pages 104 to client systems as requested and an electronic mailroom 107. In a distributed system such as that depicted in FIG. 1, computer systems that request data or services are classified as client computer systems while computer systems that provide the data or services requested by client computers are classified as server systems. Accordingly, the computer system(s) of IP data processing system 100 may be classified as server systems while computer systems of the participants may be classified as client systems. It should be apparent that a particular computer system may function both as a client system and a server system based upon whether the computer system is requesting data and/or services or receiving data and/or services. Thus, technology developers 110, patent law firms 120, service providers 130 and licensees 160 typically include one or more client systems. For example, a large corporation (technology developer) may have 150 inventors, 4 patent administrators and 2 in-house patent attorneys. Each of these individuals likely has their own computer system and can thus become a client system. Specific categories of client systems are also sometimes referred to herein. For example, an “inventor client system” is any client system associated with an inventor from one of the technology developers 110. Similarly, an “in-house client system” is any client system associated with a patent attorney, patent agent, patent administrator, secretary or other employee or contractor of a technology developer other than an inventor that has rights to create, edit or view information related to patent applications owned by the technology developer. An “outside representative client system” is an outside patent attorney, patent agent, patent administrator, secretary or other employee or contractor associated with a patent law firm 120 that represents a particular technology developer.

Each client system can display the Web pages generated by server engine 102. Each of such Web pages is uniquely identifiable by a Uniform Resource Locator (URL) and is stored in a computer-readable memory (not shown) accessible to the server engine. To view a specific document, including a Web page, a client system uses a Web browser executing on the client system to specify the URL for the document in a request (e.g., a HyperText Transfer Protocol “HTTP” request) as is known to those of skill in the art. The request is forwarded to the Web server supporting the document (server system 101 in this instance), which when it receives the request, sends the requested document to the client system. The Web browser may then display a Web page contained in the document, e.g., HTML document.

Database 106 stores information pertaining to the technology developers' intellectual property portfolios. Patent process participants (such as technology developer employees and outside law firm personnel) access this information as needed and only to extent that their access rights permit. The information in database 106 includes draft and completed invention disclosures, draft and completed patent application documents, draft and completed amendments messages and discussions pertaining to invention disclosures and patent applications, patent and patent application status information, prior art publications, office actions, assignment papers and other forms and papers filed in or generated by a patent office, etc. As described in detail below, much of this information for an individual patent application is easily accessible to a user through the user interface of the present invention.

IP data processing system 100 communicates with patent offices 140 over Internet 50 through electronic mailroom 107 and through standard mail (e.g., U.S. Postal Office First Class and Express Mail) using paper mailroom 108. For such communications in some embodiments, system 100 sets the correspondence address to mailroom 107 or 108 so that replies to the communications can be tracked and entered into database 106 as described below.

Electronic mailroom 107 is part of server 102 and includes a suite of programs that interface to the standards set by each patent office 140. For example, in order to file patent applications electronically through the USPTO the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://pto-ebc.uspto.gov/. Also, in order to track and update status information for pending patent applications, such as Examiner name, assigned art unit and class/subclass, etc., electronic mailroom 107 has the ability to interface to the USPTO's Patent Application Information Retrieval (PAIR) system using appropriate digital certificates. Electronic mailroom 107 also includes other programs to interface with other patent offices.

Paper mailroom 108 includes printers, fax machines, fax servers and other appropriate equipment to carry out all the duties necessary to file patent applications and other formal papers in patent offices using standard mailing procedures. Paper mailroom 108 also includes scanners and equipment necessary to scan papers received from technology developers 110, patent attorneys 120 and patent offices 140 into computer-readable format. Such correspondence is scanned and analyzed by optical character recognition (OCR) software to create two versions of the document: an image version and a text version created by the OCR software. The image version is stored for archival purposes. The OCR software is calibrated to recognize particular fields within common patent office forms to capture data from those forms so that appropriate data (e.g., due dates, Examiner's name, Applicant, application no., etc.) from such papers can be parsed and entered into database 106. To this end, the fields of various patent office forms that are scanned by mailroom 108 are mapped to database 106 along with the document type (determined from the form recognition sequence) in order to enable the system to determine the appropriate docketing deadlines. Alternatively, or in addition to such scanning, personnel in mailroom 108 can directly enter appropriate data into database 106 using computers or data entry terminals coupled to the database through a local area network or similar network. Once scanned into computer-readable format, communication between IP data processing system 100 and technology developers 110 can proceed in a manner that, from the standpoint of a technology developer, seems entirely paperless.

As can be appreciated from the above description, IP data processing system 100 provides a system to track all correspondence, communications, relevant dates and relevant events for every patent application owned by a given technology developer 110(i) or for every patent application for which a given patent law firm 120(i) is responsible for. Of course system 100 can also be used to track correspondence, communications, relevant dates and relevant events for a subset of such patent applications. For example, for all applications related to a particular technology, owned by a particular company group, owned by a particular law firm client, or filed after a particular date.

In tracking such information, system 100 tracks information that is useful when making decisions on whether or not to pay certain annuity or maintenance fees. As described in more detail below, system 100 provides an annuity and maintenance fee payment service that allows one or more decision makers to access this information in a quick and efficient manner. In various embodiments, The information that is accessible includes one or more of the originally filed application as well as the currently pending or allowed patent claims, the patent abstract or summary, a complete copy of the originally filed patent application including the detailed description and figures, previous decisions regarding payment of annuity and maintenance fees for the application as well as related applications and foreign counterpart applications among other data. In some embodiments, system 100 also enables comments to be entered by one or more users having appropriate access rights related to patent strategy, scope and other issues. Such comments may be used, for example, to indicate products the patent is intended to cover, advice or instructions on paying fees associated with the application including annuity or maintenance fees, advice or instructions on filing divisional applications or future claims, etc.

Prior to using system 100 to pay annuity and/or maintenance fees, a company or law firm typically performs a customer set-up or initiation routine that defines how instructions for fee payment should be routed, i.e., who is responsible for making the payment decisions or at least providing input on the decisions. For example, one customer may route all annuity/maintenance fee payment requests to an in-house patent attorney for initial consideration. These requests may appear on the client system for the in-house patent attorney as a docket alert entitled “Annuity payment due” or “Maintenance Fee payment due.” The timing of the request (e.g., how many weeks before the payment is due) as well as the frequency of such requests (the number of reminders) can also be determined during the customer set-up process.

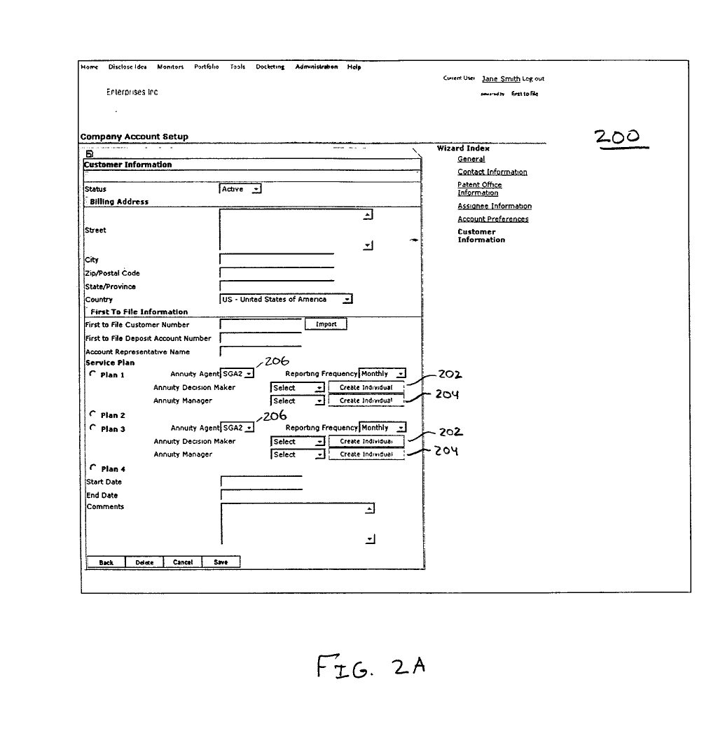

FIGS. 2A-2C are exemplary Web pages that can be used to define within routing rules within system 100 for requesting payment instructions for annuity and/or maintenance fee payments. FIG. 2A shows a Web page 200 that allows a customer, e.g., a corporation, to instruct system 100 as to a specific individual (fields 202) that will be responsible for decisions regarding annuity/maintenance fee payments as well as a specific individual who will oversee the annuity/maintenance fee payment process (fields 204). Page 200 also allows the corporation to select a third party annuity/maintenance fee payment service (field 206), such as SGA2, Inc. to make payments as instructed by the individuals identified in fields 202 and 204. Further details of how such a third party service provider receives payment instructions and communicates confirmation of the payments is discussed in more detail below.

FIG. 2B shows a Web page 210 that allows a customer to define multiple groups (field 212) with the possibility of each group having different individuals, entered through fields 214 and 216, in charge of annuity/maintenance fee for that group. It is also possible for the different groups to select different third party annuity/maintenance fee payment services (field 218). FIG. 2C shows a Web page 220 that allows a customer to define payment decision making responsibility for a specific patent application through fields 222, 224 and 226. In one embodiment, a customer typically enters appropriate data through a form such as Web page 200 to set default values for all annuity/maintenance fee payment instructions. Forms such as pages 210 and 220 can then be completed by the customer to override the default values for specific groups or divisions or specific cases.

As previously mentioned, system 100 tracks all sorts of information related to patent applications for an individual company or law firm. The tracked information includes application filing dates and annuity and maintenance fee due dates. In one embodiment, annuity and maintenance fee due dates are calculated by rules specific to each country an application is filed in. Such calculations can be performed any time after the filing of the application in the particular country. In one embodiment the filing of an application is a triggering event that results in a docketing program associated with server system 100 calculating due dates for annuity payments when dictated by appropriate rules and the granting of a patent application is a triggering event that results in the docketing program calculating appropriate due dates for maintenance fee payments. The calculated due dates are then stored in database 100 and used to generate future reminder notices for annuity and maintenance fee payments. One example of how a docket system can be used to generate annuity and maintenance fee reminder and due dates is described in concurrently filed U.S. Application Ser. No. 09/______ (Attorney Docket No. 020313-001810US), entitled “Docketing System,” listing Cecily Anne Snyder as inventor, which is hereby incorporated by reference in its entirety.

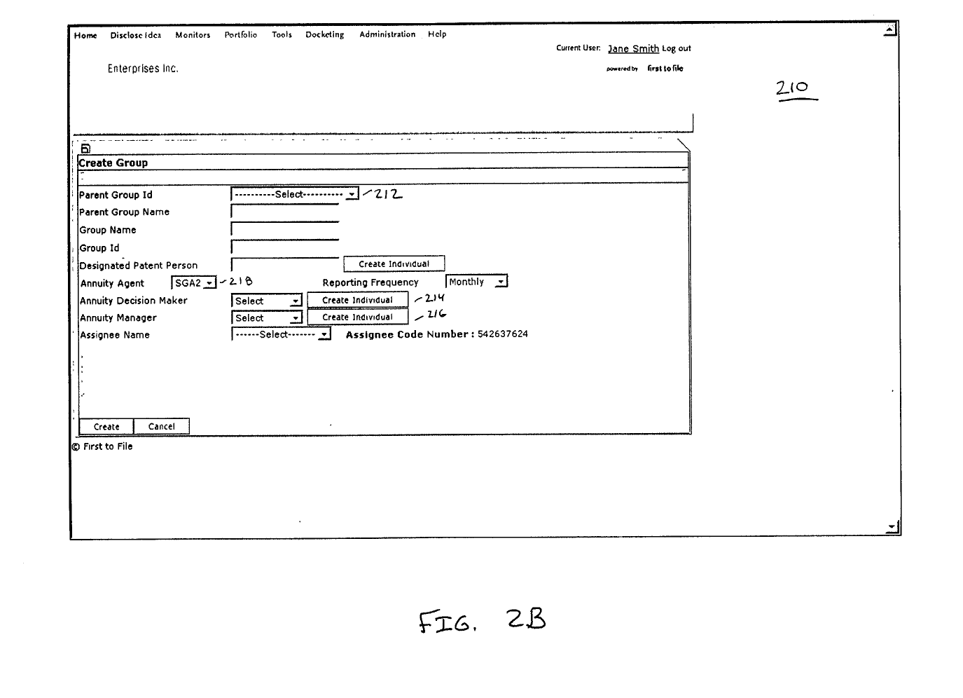

Once docketed, requests for annuity and maintenance fee payment instructions are routed according to the routing rules set up during the customer set up process. These routing rules dictate the frequency of the requests as well as which client systems the requests are sent to. A variety of different formats can be used to present the requests for payment instructions to an appropriate client system. FIG. 3 is an exemplary Web page 230 that is used in one embodiment of the invention to present such instruction requests. Web page 230 presents to the client system a list of all annuity and maintenance fee payments that are due within a certain period (e.g., one month) as defined during user set-up. This page view is useful if a particular customer has many patent files and prefers to make annuities payment decisions in a sort of batch process, for example, once a month. An individual client system can view FIG. 3 by selecting a menu selection (e.g., as a selection under “monitors” button 232), by selecting an alert message that shows up in the client systems alert monitor. In another embodiment, annuity and maintenance fee instructions can be requested and received when a client system is reviewing data or status information associated with a particular case.

As shown in FIG. 3, two different annuity payment instructions 234 and 236 are presented to a client system via Web page 230 in this example. Instruction 234 is for payment of the sixth annuity fee in Taiwan for a case entitled “Variable Latency” while instruction 236 is for payment of the fourth annuity fee in Australia for a case entitled “A New Family of Penam Antibiotics.” For each instruction the client system can select via fields 238 to pay the fee, not pay the fee or put the decision on hold until a later date. Although not shown, an additional “Pay All” button can be selected to expedite the process for customers that regularly pay all such fees.

If the client system would like further information about the case an annuity or maintenance fee decision is required for, the client system can select the case title. In one embodiment, selecting the title presents a Web page that displays predetermined summary information about the case. The information may include, for example, one or more exemplary claims, an abstract or summary of the invention, a thumbnail exemplary figure, user comments and/or previous payment instruction history. The information displayed may be customized based on the preferences of the customer or an individual user within the customer. Such customization may be performed during the customer set-up process.

In another embodiment, selecting the case title links the client system to a Case Data Unit, which is a collection of data and/or electronic documents (or references to the electronic documents) that are related to a particular case, e.g., a patent application in a particular country. In some instances a case may actually include more than one patent application, for example, where a Continued Prosecution Application (CPA) is filed in the USPTO under rule 37 C.F.R. 1.53(d). The Case Data Unit may be implemented as a data structure, a file, a database, or any other structure capable of storing data and/or documents. In one embodiment, a Case Data Unit stores a variety of bibliographic information (referred to herein as case meta data) associated with a patent case, as well as one or more documents related to the patent case. Case meta data stored in the Case Data Unit may include, for example, a case title, a patent application number (serial number), a filing date, a patent number, a patent date, publication numbers and associated publication dates, a client reference number, a law firm reference number, the country the application is filed in, a list of inventors, a status indicator (e.g., filed, issued, abandoned, etc.), an assignee, information related to the assignment (e.g., an assignment recordation date and reel and frame number), a responsible attorney, a working attorney, priority information (e.g., serial numbers, filing dates and countries of any parent cases), etc.

The electronic documents (hereinafter referred to as “documents”) stored in a Case Data Unit may include a variety of documents of different document types. Specific examples of document types include an invention disclosure, a filed patent application, patent drawings, old versions of patent applications and drawings, other patent papers (e.g., other documents filed in the patent office including Responses to Office Actions, Information Disclosure Statements, Petitions, etc.); forms, image files (e.g., locked documents of .pdf or a similar type of image file format corresponding to a granted patent (if a patent was granted for the case) as well as scanned copies of any office actions received, responses filed in the patent office, filing receipts, etc. issued during prosecution of the patent application); notes (e.g., attorney notes, inventor notes, notes from other interested parties regarding the importance of the patent to a companies business, products or competitors business or products, etc.); mail (e.g., email messages or alerts) and prior art references among others. It is to be understood that this list is for illustrative purposes only and various embodiments of the invention can include more or fewer document types as appropriate.

Each document stored in a Case Data Unit also includes appropriate document meta data that identifies the document and its history. Examples of document meta data include document ID, document type, originator, status, security profile, file format, creation date, last modified date, last modified by, physical file attributes, search field key words, completion date, witness names and dates, etc. The combination of a document, its document meta data and other information related to the document is referred to herein as a document entity.

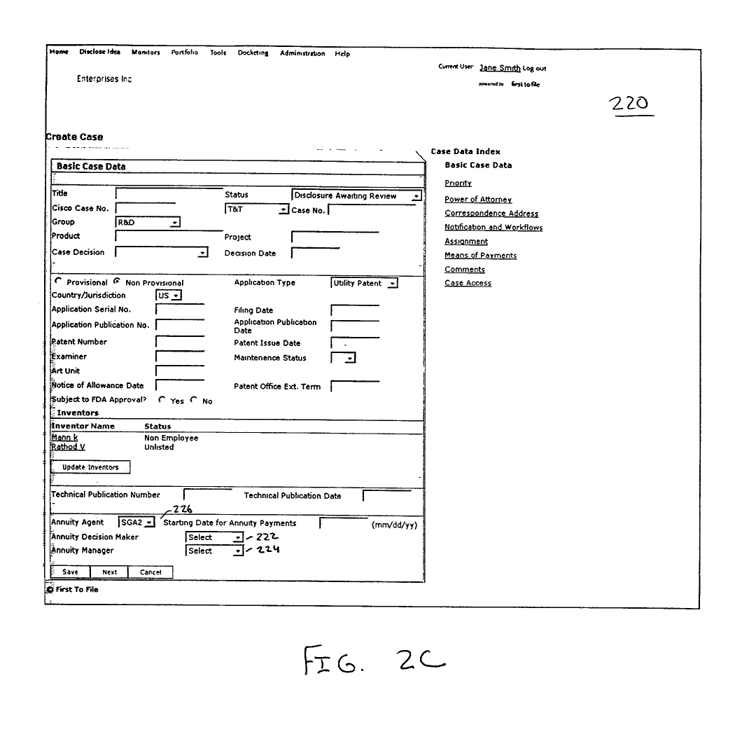

In one embodiment the Case Data Unit is presented to the client system through a trifold or similar graphical user interface. An example of such a trifold user interface 250 for the “Variable Latency” case shown in FIG. 3 (related to annuity payment instruction 234) is shown in FIG. 4. Interface 250 (a Web page 250 in this example) includes four primary display sections including: correspondence section 252, file history section 254, document section 256 and case summary section 258. Correspondence section 252 includes multiple folders with each folder including specific types of information, for example, a folder 260 may include a list of all correspondence between a law firm and in-house attorneys, patent administrators and inventors for the selected patent matter (“Variable Latency Cut Through Bridge” in this particular example). Individual pieces of correspondence, for example email messages, may be contained in folder 260 and accessible by selecting on an html link that leads to the underlying correspondence document. Thus, to view an individual correspondence in folder 260, the user of the client system simply expands the folder and selects the link associated with the desired correspondence document. Similarly, each of the documents shown in file history section 254 and document section 256 are also html links to underlying documents. Correspondence documents can be email messages, word processing documents, scanned image files as well as other types of documents.

File history section 254 lists all the official papers that have been sent to and received from the patent office. These documents (referred to as “patent documents” herein) are stored in an image format (e.g., .pdf, .bmp or .tiff file formats). The image format preserves the actual look of any paper documents that were either transmitted to a patent office in paper format or received from a patent office in paper format. The image format also prevents the documents from being accidentally modified or edited in most instances. In some embodiments, the patent documents in file history section 254 are also locked so that they cannot be edited or deleted by most users. As shown in FIG. 4, file history section 254 includes html links to granted Letters Patent 260, Issue Notification 261, Issue Fee 262, Notice of Allowance 263, a Response to Final Office Action 264 and other documents filed in the Patent Office—all stored in an image format and locked from further editing.

Document section 256 lists files associated with the selected patent application that were created by the applicant, the applicant's attorney or similar party. These patent files include documents such as invention disclosures that are not filed in a patent office as well as patent applications, responses to office actions and other documents that either were filed or are going to be filed in a patent office. Many of the patent files listed in document section 256 are stored in a format in which they are accessible, and editable if they are not locked, to the application program from which they were created or with which they are associated. Typically these files are stored in a format native to the associated application. For example, an invention disclosure, a patent application and a response to an office action that were all created by MS Word™ 2000 may all be stored in a .doc file. In other embodiments, however, it is possible to store these files in other formats such as text files (.txt) or compressed files (.zip) that are readily convertible to native file formats by the application program itself. As with other sections, documents in section 256 may be organized in file folders. Also, in some embodiments individual documents in the section 256 may include separate sections that are accessible independent of the other sections. For example, the originally filed patent application may be stored in a filing package 265. Within filing package 265 are separate documents such as a patent application, an assignment form, a power or attorney form, and an oath and declaration form (not shown in FIG. 4). The patent application may include separate sections such as abstract, specification, claims, that are accessible independent of each other if desired, for example, if the client system wants to quickly review the claims without looking at the rest of the patent application document.

Finally, case summary section 258 includes summary information about the particular patent application such as one or more of the invention's title, the list of inventors, the application filing date, the application number, list of countries the application was filed in, etc. In the embodiment illustrated in FIG. 4, a small subset of this information is displayed directly in section 258 (e.g., the title) and more detailed summary information can be accessed by selecting an information icon 266. Further details on this and other appropriate graphical user interfaces is presented in U.S. application Ser. No. 09/919,764, filed on Jul. 31, 2001 (Attorney Docket No. 020313-001100US), entitled “User Interface for Managing Intellectual Property,” listing Jeffry J. Grainger as inventor, which is hereby incorporated by reference in its entirety.

Additionally, in some embodiments, if the client system would like to ask for an opinion from another (e.g., an outside attorney) regarding whether or not a specific annuity or maintenance should be paid, the client system can create an Alert that is sent to another appropriate client system (the outside attorney in this example). The Alert can be created by selecting a “Second Opinion” button displayed next to each case (not shown in FIG. 3). The created Alert will then appear in the outside attorney's alert list and the outside attorney will have access to all the same information (abstract, claims, etc.) as did the original client system (annuity decision maker). The outside attorney can then respond to the alert with his or her recommendation as to whether or not to pay the fee and the response will communicated to the annuity decision maker who created the initial alert.

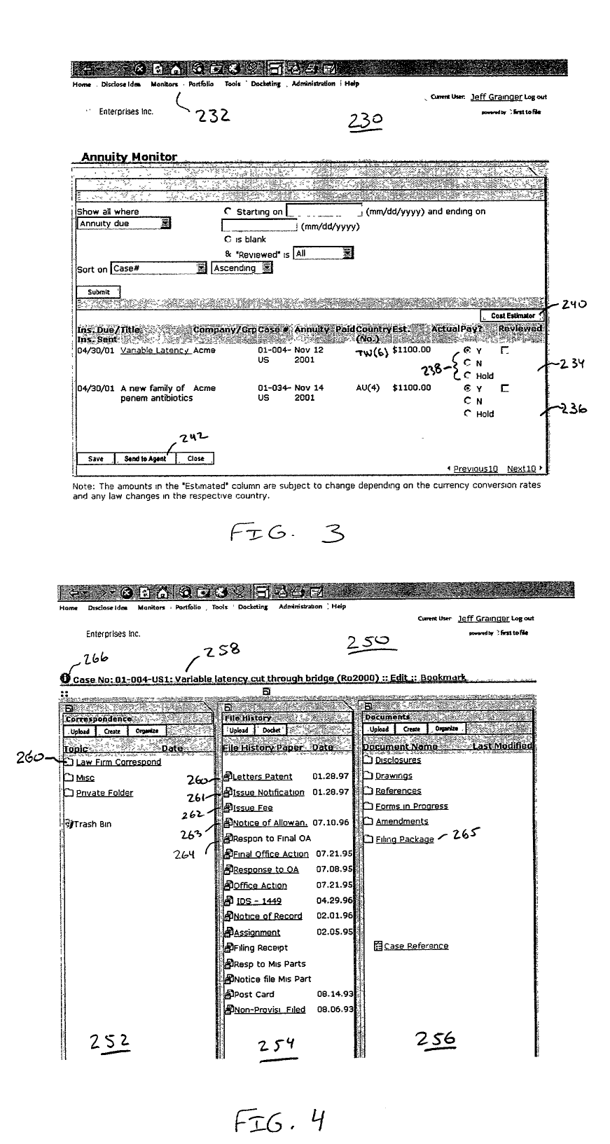

Another feature provided by system 100 that facilitates the decision making process for annuity and maintenance fees is available by selecting “Cost estimator” button 240. Upon selecting cost estimator button 240, a Web page is presented that can be used to estimate the cost of all future annuity and/or maintenance fees that are either due or will expected to be due for a particular case. FIG. 5 shows on example of a Web page 270 that can be used estimate annuity payments due for filing a new patent application in nine different countries. Individual countries can be selected to be included or excluded in the cost estimator through selection fields 272. In other embodiments, Web page 270 lists only annuity payments for the particular country in which an annuity payment decision is required.

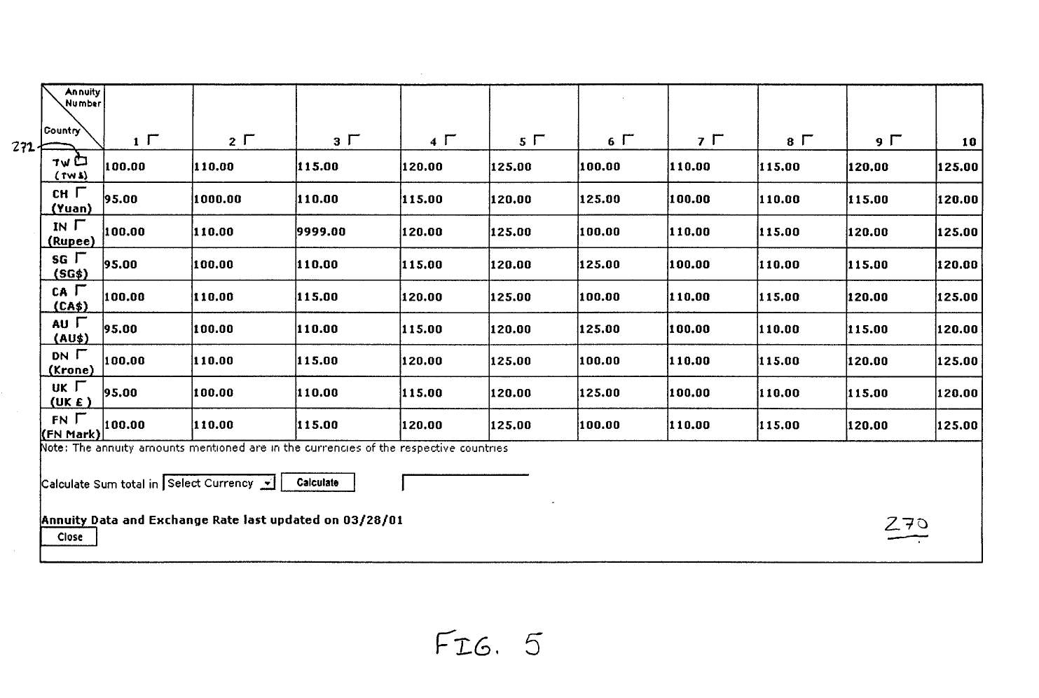

In some embodiments IP data processing system 100 also provides a feature that, upon selection of an appropriate icon such as a “Family Tree” icon not shown in the figures, will depict graphically the relationship between the current application and other members of its patent family. FIG. 6 is one example of a Web page 280 that graphically depicts such a family tree. As shown in FIG. 6, Web page 280 shows the family tree of a Japanese patent application 282 for which an annuity payment is due. Web page 280 shows that application 282 is a national filing from a PCT application 284, which in turn claims priority from a U.S. filing 286. All patent numbers, application numbers, filing dates and other data shown in FIG. 6 is fictional.

In some embodiments IP data processing system 100 also retains a history of annuity and maintenance fee payment instructions. In some embodiments this history is available for review by a client system by selecting a “payment history” button (not shown on Web page 230) for the case. In other embodiments, payment history is accessible through the link associated with the case title. In other embodiments, the payment history of annuity and/or maintenance fee payments for related applications including applications filed in other countries is available for review by selecting an appropriate icon displayed on Web page 230.

When payment of the annuity fee and/or maintenance fees are actually due, some embodiments system 100 can make the payments on behalf of the customer and automatically deduct the payment amounts directly from accounts associated with the client system. Alternatively, the amounts can be billed to the client system. In various embodiments, system 100 can submit an annuity or maintenance fee payment directly to the appropriate Patent Office pursuant along with information identifying the annuity being paid. A confirmation of the annuity payment will then be sent to the client system and a payment receipt will be sent to IP data processing system 100 from the Patent Office. The receipt will become a document within system 100 associated with the appropriate case. These receipts can be viewed by client system with appropriate rights just as other documents associated with the case and the receipts can be compared versus payment instructions as a final accounting measure to ensure payments were properly received. System 100 can even be set up to track such receipts and if they are not received within a time period specified during user set-up, send an alert to the appropriate client system of the technology developer indicating that a problem with the annuity payment may have occurred.

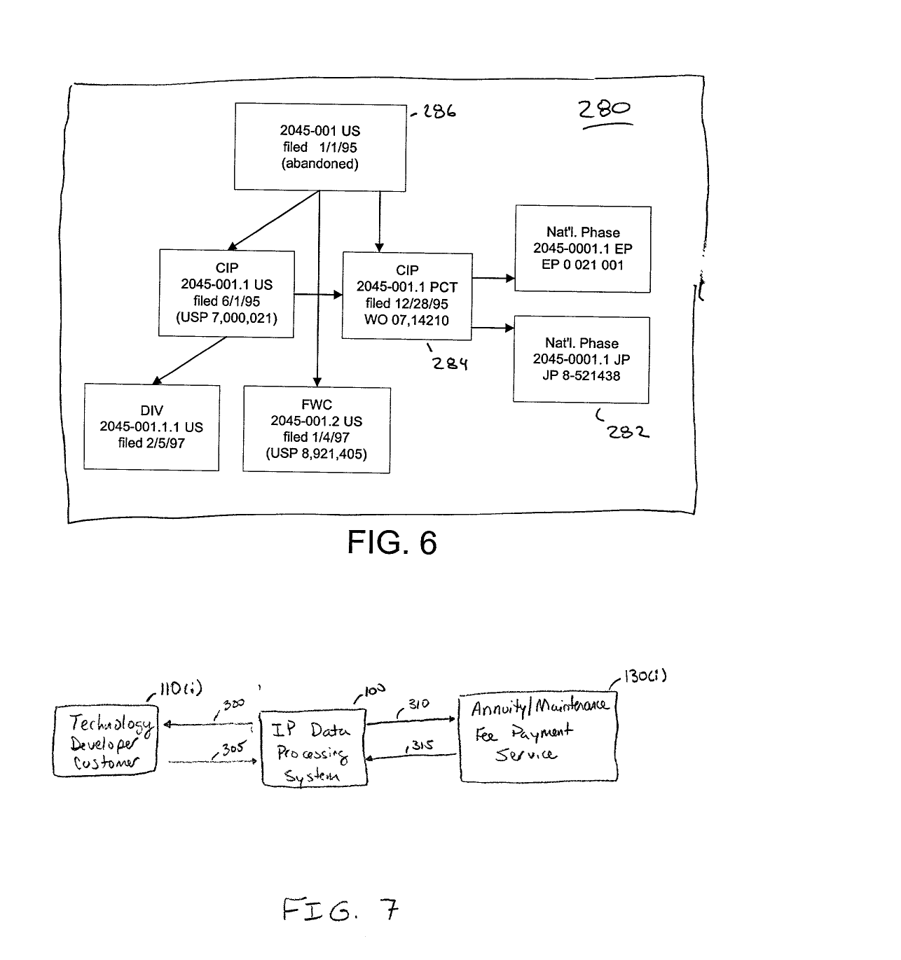

In other embodiments, however, payments are made by a third party annuity fee payment service 130(i). FIG. 7 is a simplified diagram showing how requests 300 for annuity/maintenance fee payment instructions are generated by IP data processing system 100, instructions 305 for such annuity/maintenance fee payments are generated by a client system at a technology provider 110(i) [or, alternatively, by a patent attorney at a law firm 120(i)], payment instructions 310 are then communicated from system 100 to an annuity/maintenance fee service provider 130(i) and instructions 315 confirming such payment are then communicated back to IP data processing system 100. In one embodiment, payment instructions 310 are communicated from system 100 to service provider 130(i) in real time upon selecting a “Send to Agent” icon 242 (shown in FIG. 3). In other embodiments, instructions are sent in batch mode at one or more predetermined times and in still other embodiments, agent 130(i) logs onto system 100 to retrieve annuity payment instructions.

As described above, one benefit of the maintenance fee/annuity fee payment feature of the present invention is that if the client system wishes to look at data for the case at hand (e.g., the case Abstract, the current claims, the inventors, the business group, etc.), the client system simply selects the title or reference number associated with the case to get to this and other underlying data. Thus, the client system has direct and immediate access to all the documents that are useful to facilitate a decision for paying the fee. This is true whether the client system tasked with annuity/maintenance fee payment is the inventor, an in-house attorney, a patent administrator or an outside attorney or patent agent. Additionally, in the context of an ASP model, throughout this entire process all participates are looking at and reviewing the same set of data stored in database tables accessible by system 100. This provides a high degree of accuracy in the decision making process as well as a high degree of data integrity.

Having fully described several embodiments of the present invention, other equivalent or alternative methods of practicing the invention will be apparent to those skilled in the art.

What is claimed is:

1. A computer-implemented method of allowing payment of an annuity or maintenance fee associated with an intellectual property document, said method comprising:
storing, on a computer-readable medium, a due date for said annuity or maintenance fee payment and information pertaining to a scope of protection provided by said intellectual property document;
in response to said due date, communicating an alert to a first designated client system over a first communication network, wherein said alert includes said due date and allows said recipient to view said information and indicate whether said annuity or said maintenance fee should be paid;
receiving, over said first communication network, a payment instruction from said first designated client system regarding payment of said annuity or said maintenance fee;
storing said instruction in a database; and
communicating said instruction to a second designated client system by a second communication network.

2. The method of claim wherein said intellectual property document is a patent document.

3. The method of claim 2 wherein said information comprises one or more of a summary of an invention or a patent claim.

4. The method of claim 2 wherein said first and second communication networks are each one or more of the Internet, a local area network, a wide area network, a wireless network, an intranet or a virtual private network.

5. The method of claim 4 wherein said first and second communication networks are each the Internet.

6. The method of claim 2 wherein said second designated client system is associated with an annuity payment service.

7. The method of claim 6 wherein said payment instruction is communicated to said second designated client system with a plurality of payment instructions in a batch process.

8. A computer-implemented method of allowing payment of an annuity or maintenance fee associated with a patent document, said method comprising:
storing, on a computer readable medium accessible to a server system, patent information related to said patent document, said patent information including one or more of a patent claim and a summary of said patent document;
generating, from said server system, a notice of a due date for said annuity or said maintenance fee;
communicating said notice to a client system via a Web page, wherein said Web page allows said client system to system to view said information and indicate whether said annuity or said maintenance fee should be paid.

9. The method of claim 8 wherein said patent information includes a complete copy of a patent application, a filing date of said application and, if any exist, previous payment instructions for said annuity or said maintenance fee.

10. The method of claim 9 wherein said patent information further includes payment information for annuity or maintenance fees for related patent documents or foreign counterpart patent documents.

11. The method of claim 9 further comprising receiving at said server system an instruction from said client system to initiate payment of said maintenance fee or said annuity payment.

12. The method of claim 11 further comprising generating a confirmation alert confirming payment of said maintenance fee or said annuity payment and communicating said confirmation alert to said client system.

13. The method of claim 11 further comprising communicating a payment instruction to a third party maintenance fee/annuity fee payment service for payment of said annuity of maintenance fee when said client system indicates said fee should be paid.

14. The method of claim 8 wherein said communicating step comprises communicating a plurality of notices associated with a corresponding plurality of patent applications to said client system via said Web page, wherein said Web page allows said client system to system to view said information for each of said plurality of patent applications and indicate whether an annuity or maintenance fee associated with each of said patent applications should be paid.

15. The method of claim 14 wherein said information for a selected patent application is viewable on said Web page by selecting a link associated with said selected patent application.

16. The method of claim 8 wherein said Web page allows said client system to select whether a decision to pay said annuity or maintenance fee payment: pay, do not pay or decide at a later time.

17. The method of claim 8 wherein said client system can select to receive a cost estimate on payment of said annuity or maintenance fee that includes the cost of paying future annuity or maintenance fees that will come due for said patent application.

18. A computer-implemented method of allowing payment of an annuity or maintenance fee associated with a patent document, said method comprising:
storing, on a computer readable medium accessible to a server system, patent information related to said patent document, said patent information including one or more of a patent claim and a summary section;
generating, from said server system, a notice of a due date for said annuity or said maintenance fee;
communicating said notice to a first designated client system via a Web page, wherein said Web page allows said client system to system to view said information and indicate whether said annuity or said maintenance fee should be paid;
receiving a payment instruction from said client system regarding payment of said annuity or said maintenance fee;
storing said payment instruction in a database; and
communicating said payment instruction to a second designated client system over a communication network.

19. The method of claim 18 wherein said second designated client system is an annuity payment service.

20. The method of claim 19 wherein said payment instruction is communicated to said annuity payment service over the Internet.

21. The method of claim 20 wherein said payment instruction is communicated with a plurality of payment instructions that designated for delivery to said annuity payment service in a batch process.

22. The method of claim 19 wherein said second designated client system pays said annuity or maintenance fee and thereafter, communicates confirmation of said payment to said server system.

23. A method of allowing payment of an annuity or maintenance fee associated with a patent application, said method comprising:
storing, on a computer readable medium accessible to a server system, data and documents associated with a particular patent application, wherein said data and documents are organized in a Case Data Unit;
generating, from said server system, a notice of a due date for said annuity or said maintenance fee;
communicating said notice to a first designated client system via a Web page, wherein said Web page (i) allows said client system to system to access said Case Data Unit to view said data and documents and (ii) allows said client system to indicate whether said annuity or said maintenance fee should be paid;
receiving a payment instruction from said client system regarding payment of said annuity or said maintenance fee;
storing said payment instruction in a database; and
communicating said payment instruction to a second designated client system over a communication network.

24. The method of claim 23 wherein said Case Data Unit comprises meta-data associated with said patent document, said meta-data comprising one or more of an application number, a filing date, a list of inventors and a file number.

25. The method of claim 24 wherein said documents comprise one or more of an invention disclosure document, attorney notes, inventor notes, an originally filed patent application, a response to an office action, an information disclosure statements, a petition, a granted patent stored in an image file format; an office action stored in an image file format.

26. A method of allowing an employee associated with either a technology developer or a law firm to pay, from a first client system capable of being connected to a public network, an annuity or maintenance fee for a patent document assigned to said technology developer, said method comprising:
connecting said client system to a server system through a public network;
receiving, at said client system, a notice of a due date for payment of said annuity or said maintenance fee, wherein said notice (i) is part of a Web page that is generated by said server system and viewable on said client system through a browser executing on said client system, (ii) allows said client system to view data and documents associated with said patent document that are stored on a computer-readable memory coupled to said server system and (iii) allows said client system to indicate whether said annuity or said maintenance fee should be paid;
generating a payment instruction from said client system regarding payment of said annuity or said maintenance fee; and
communicating said payment instruction to said server system over the public network.

27. The method of claim 26 wherein said public network is the Internet.

28. The method of claim 27 wherein said data comprises meta-data associated with said patent document, said meta-data comprising one or more of an application number, a filing date, a list of inventors and a technology developer reference number.

29. The method of claim 28 wherein said documents comprise one or more of an invention disclosure document, attorney notes, inventor notes, an originally filed patent application, a response to an office action, an information disclosure statements, a petition, a granted patent stored in an image file format and an office action stored in an image file format.

30. A method of allowing an employee associated with either a technology developer or a law firm to pay, from a first client system capable of being connected to a public network, an annuity or maintenance fee for a patent document assigned to said technology developer, said method comprising
storing, on a computer readable medium accessible to a server system, data and documents associated with a particular patent application, wherein said data and documents are organized in a Case Data Unit;
generating, from said server system, a notice of a due date for said annuity or said maintenance fee;
communicating said notice to a first designated client system via a Web page over a public network, wherein said Web page (i) allows said client system to system to access said Case Data Unit to view said data and documents and (ii) allows said client system to indicate whether said annuity or said maintenance fee should be paid;
receiving a payment instruction from said client system over the public network regarding payment of said annuity or said maintenance fee; and
storing said payment instruction in a database coupled to said server system.

31. The method of claim 30 wherein said public network is the Internet.

32. The method of claim 31 wherein said payment instruction is communicated to a second designated client system over the Internet and wherein said annuity or said maintenance fee is paid by said second designated client system.

33. The method of claim 31 wherein said Case Data Unit comprises meta-data associated with said patent document, said meta-data comprising one or more of an application number, a filing date, a list of inventors and a file number.

34. The method of claim 33 wherein said documents comprise one or more of an invention disclosure document, attorney notes, inventor notes, an originally filed patent application, a response to an office action, an information disclosure statements, a petition, a granted patent stored in an image file format and an office action stored in an image file format.

35. A server system that facilitates payment of annuity and/or maintenance fee payments associated with patent documents, said server system comprising:
(a) a processor;
(b) a database; and
(c) a computer-readable memory for storing a computer program;
wherein said processor is operative with said computer program to:
store, in said database, patent information related to a patent document, said patent information including one or more of a patent claim and a summary section;
generate a notice of a due date of a annuity or maintenance fee associated with said patent document; and
communicate said notice to a client system via a Web page, wherein said Web page allows said client system to system to view said information and indicate whether said annuity or said maintenance fee should be paid.

36. A networked system comprising:
(a) a communication network;
(b) a client system coupled to the communication network, said client system comprising a processor and a display;
(c) a server system coupled to the communication network, said server system comprising a processor, a database, and a memory for storing a computer program;
wherein said processor is operative with said computer program to:
store, in said database, patent information related to a patent document, said patent information including one or more of a patent claim and a summary section;
generate a notice of a due date of a annuity or maintenance fee associated with said patent application; and
communicate said notice to said client system via a Web page, wherein said Web page allows said client system to system to view said information and indicate whether said annuity or said maintenance fee should be paid.
